(19) United States
(12) Patent Application Publication
(10) Pub. No.: US 2015/0362120 A1
(43) Pub. Date: Dec. 17, 2015

(54) Pipe Insulation System and Method

(71) Applicant: Strom W. Smith, Gulfport, MS (US)

(72) Inventor: Strom W. Smith, Gulfport, MS (US)

(21) Appl. No.: 14/737,937

(22) Filed: Jun. 12, 2015

Related U.S. Application Data
(60) Provisional application No. 62/011,099, filed on Jun. 12, 2014.

(51) Int. Cl. F16L 59/14

(52) U.S. Cl. CPC F16L 59/14

(57) ABSTRACT

Embodiments of an insulation system for process vessels or piping and methods of use generally include a heat-reflective metal foil wrapped around a pipe or vessel and an external heating means, if so equipped; a shell disposed circumferentially around the foil wrapped pipe or vessel and spaced therefrom, wherein the shell has a heat-reflective interior surface; one or more layers of an insulation material provided circumferentially around the shell; and, optionally, a protective coating on, and/or a second shell disposed around, the outermost layer of insulation material. Alternative embodiments of an insulation system for process vessels or piping and methods of use generally include a heat-reflective metal foil wrapped around a pipe or vessel and an external heating means, if so equipped; one or more layers of an insulation material provided circumferentially around the foil-wrapped structure; and, optionally, a protective shell provided circumferentially around the outermost layer of insulation material.

### CROSS-REFERENCE TO RELATED APPLICATIONS

This application claims the benefit of U.S. Provisional Application No. 62/011,099 filed on Jun. 12, 2014, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to pipe and vessel insulation systems. More particularly, the present invention relates to a system and method for insulating industrial and process piping and vessels.

2. Description of the Related Art

Insulation systems are commonly practiced for industrial piping and vessels. Some insulation systems include heat tracing systems utilizing heating elements to maintain or raise temperatures of pipes and vessels. Heat tracing may take the form of an electrical heating element run in physical contact along the length of a pipe. In industrial applications, heat tracing may be accomplished by circulating steam or another fluid through pipes or tubes adjacent the pipe or vessel to be heated. In other industrial applications, electrical impedance type heating is employed, wherein terminals are attached to each end of a pipe, and a low voltage current is passed through it. The pipe thus acts as its own heating element.

The heated pipe or vessel is covered with thermal insulation to retain heat losses from the pipe. Heat generated by whatever means maintains the temperature of the pipe. Such heating is often used to maintain existing temperatures in a piping system when the contents are subject to solidification at ambient temperatures.

### BRIEF SUMMARY OF THE INVENTION

An exemplary embodiment of the present invention comprises an insulation system for process vessels or piping comprising a reflective metal foil wrapped around a pipe or vessel equipped with an external (to the pipe or vessel) heating means. A shell comprising an insulating material, such as aluminum, is disposed circumferentially to the foil wrapped pipe or vessel, with an air gap there between. The interior surface of the shell comprises a heat-reflective surface. Disposed exterior to the shell are one or more layers of an insulation material, such as an aerogel. A protective coating or a second shell may be applied around the outermost layer of insulation material. In another exemplary embodiment, one or more layers of insulating material are provided circumferentially to the foil wrapped pipe or vessel, with substantially no air gap there between. A protective coating and/or shell may be applied around the outermost layer of insulation material.

### BRIEF DESCRIPTION OF THE DRAWINGS

For a more complete understanding of embodiments of the invention, reference is now made to the following Detailed Description of Exemplary Embodiments of the Invention, taken in conjunction with the accompanying drawings, in which:

FIG. 1 is a view of an exemplary insulation system of the present invention.

FIG. 2 is a view of an exemplary insulation system of the present invention.

FIG. 3 is a view of an exemplary insulation system of the present invention.

FIG. 4 is a view of an exemplary alternative insulation system of the present invention.

FIG. 5 is a view of an exemplary alternative insulation system of the present invention.

FIG. 6 is a view of an exemplary alternative insulation system of the present invention.

### DETAILED DESCRIPTION OF EXEMPLARY EMBODIMENTS OF THE INVENTION

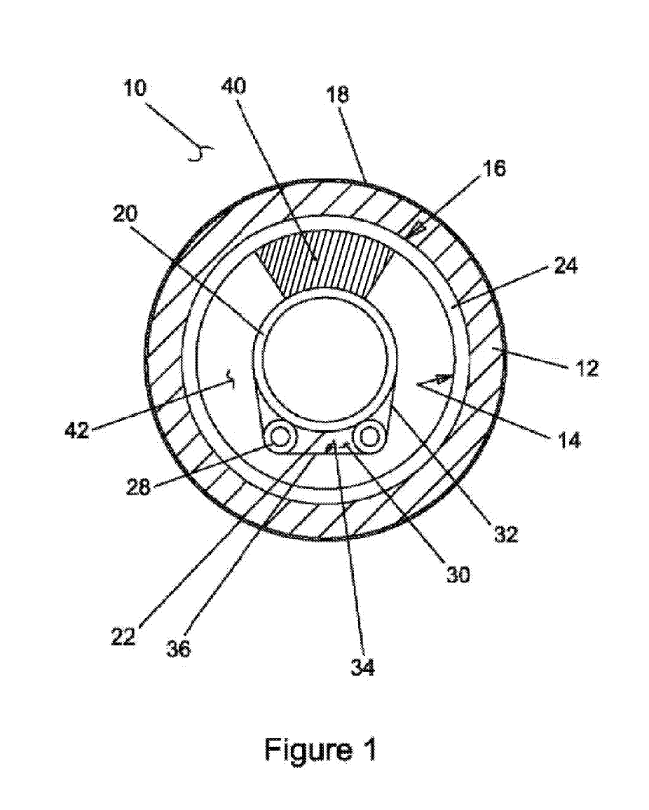

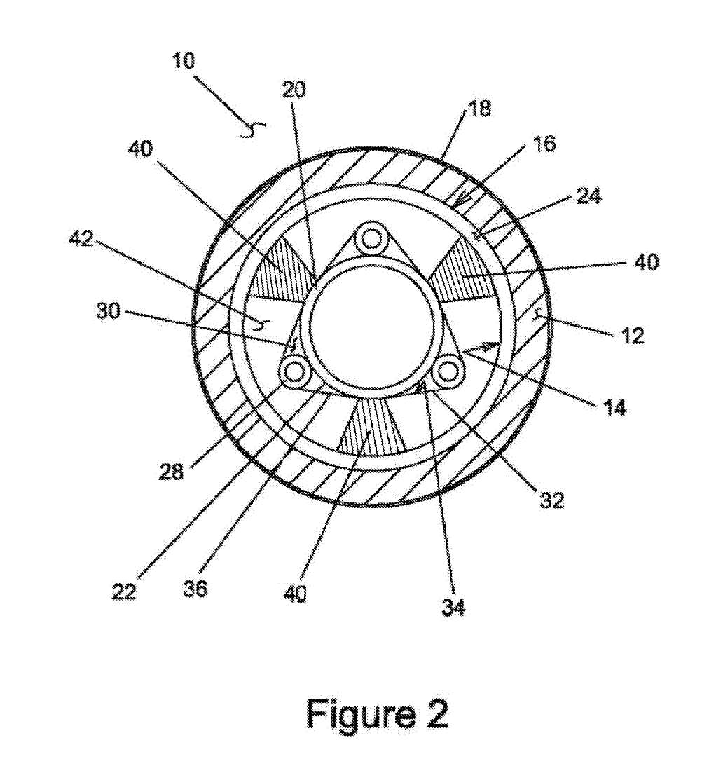

Referring to FIG. 1, there is shown an embodiment of a pipe insulation system 10 of the present invention. In the exemplary embodiment of FIG. 1, a pipe 20 to be insulated is depicted. In one embodiment, system 10 of the present invention comprises one or more heating elements 28 provided exterior to pipe 20 and proximate an exterior surface 22 thereof. In an exemplary embodiment of the present invention shown in FIG. 1, two heating elements 28 are provided. In a second exemplary embodiment of the present invention shown in FIG. 2, three symmetrically disposed heating elements 28 are provided. As one skilled in the art would understand, any useful number of heating elements and arrangement thereof may be employed. In an exemplary embodiment of the present invention, heating elements 28 comprise tubes capable of circulating a fluid such as, but not limited to, steam. In a second exemplary embodiment, heating elements 28 utilize electric energy and may comprise a heat tape as is generally known in the art. In an embodiment of the present invention not depicted in the drawings, pipe 20 is heated by electrical impedance means and no exterior heating elements 28 are provided. The above listed heating methods and means are only exemplary, and one skilled in the art would understand that the present invention is applicable to insulation of any suitable pipe or vessel, and therefore may be used with pipes or vessels heated by other processes.

In one embodiment of the present invention, pipe 20 has an outer diameter of about 4.5 inches and a thickness of about 0.237 inches, and heating elements 28 comprise tubes adapted to provide fluid flow of steam. One skilled in the art would understand that various embodiments of the present invention could utilize pipes 20 (or vessels) having different diameters and thicknesses.

In an exemplary embodiment of the present invention, a metal foil 32 is wrapped around pipe 20 and heating elements 28. In an exemplary embodiment of the present invention, metal foil 32 comprises aluminum. In one embodiment, metal foil 32 as utilized in the present invention comprises a heat-reflective or “shiny” surface 34 that faces pipe 20 and heating elements 28. A metal foil 32 having any suitable thickness (gauge) may be employed in the present invention. In one embodiment of the present invention, metal foil 32 has a thickness of less than about than 0.2 millimeters. In one embodiment of the present invention, metal foil 32 comprises aluminum and has a thickness of between about 0.016 millimeters and about 0.024 millimeters.

In an exemplary embodiment of the present invention, application of metal foil 32 is achieved by wrapping in an angled manner so as to provide the ability to only partially overlap metal foil 32 on itself. In this fashion, metal foil 32 is provided spirally along the length of pipe 20. The angle of spirality may be varied to provide a desired wrapping geometry such that one or more layers of metal foil 32 are provided at substantially all locations along pipe 20. In one embodiment of the present invention, metal foil 32 is wrapped around pipe 20 and heating elements 28 in such a manner that an overall layer count of about 6 to 8 layers is provided. In addition, the metal foil 32 wrapping may be repeated (over previously applied metal foil wrapping) as many times as needed to achieve a desired overall metal foil 32 thickness from multiple wrappings.

Spaces or gaps 30 define a region exterior to heating elements 28 and intermediate exterior surface 22 of pipe 20 and heat-reflective surface 34 of metal foil 32. Not to be limited by theory, it is believed that heat-reflective surface 34 reflects thermal radiation emanating from heating elements 28 back toward pipe 20, and metal foil 32 conducts heat there through, thereby distributing heat around pipe 20. Depending on the number of heating elements 28 and the dimensions thereof, the number and dimensions of gaps 30 will vary. In the embodiments of the present invention depicted by FIG. 1 and FIG. 2, the number and placement of heating elements 28 results in direct contact between portions of exterior surface 22 of pipe 20 and portions of heat-reflective surface 34 of metal foil 32. Other embodiments of the present invention may comprise a number and placement of heating elements 28 that results in fewer or no points of contact between exterior surface 22 of pipe 20 and heat-reflective surface 34 of metal foil 32. In still another embodiment of the present invention (not shown), wherein pipe 20 is heated by electrical impedance and no heating elements 28 are provided, substantially all of heat-reflective surface 34 of metal foil 32 is in direct contact with exterior surface 22 of pipe 20.

In an exemplary embodiment of the present invention, exterior to an outer surface 36 of metal foil 32, one or more spacers 40 are provided to maintain spatial distance from a shell 24 disposed circumferentially to the foil wrapped pipe 20 and heating elements 28. In other embodiments (not shown), substantially no special distance is maintained between shell 24 and the foil wrapped structure. In the embodiment of FIG. 1, one spacer is employed, while in the embodiment of FIG. 2, three substantially symmetrically disposed spacers are utilized; however, the invention is not so limited and one skilled in the art would understand that the number of spacers and arrangement thereof can be varied as may be required. In other embodiments (not shown), spatial distance between shell 24 and outer surface 36 of metal foil 32 may be maintained by means other than spacers 40, such as but not limited to, connection of a portion of shell 24 to pipe components such as flanges, or connection, directly or indirectly, of shell 24 to external support structures.

In an exemplary embodiment, shell 24 is constructed of a metal or metal alloy, such as an aluminum alloy or a steel alloy; however, the invention is not so limited and shell 24 may comprise any material suitable for use in a particular industrial application, as would be understood by one skilled in the art. In one embodiment of the present invention, shell 24 comprises aluminum. Shell 24 may comprise a heat-reflective inner surface 14. In one embodiment, heat-reflective inner surface 14 is polished to improve heat reflection. In one embodiment, a heat-reflective coating (not shown) may be applied to heat-reflective inner surface 14 to improve heat reflection. In an exemplary embodiment, the heat-reflective coating is a heat reflective paint having reflectance of at least 0.70. In a further exemplary embodiment, the heat-reflective coating may contain hollow ceramic spheres to enhance insulation. In a further exemplary embodiment, the coating further comprises reflective metallic elements, such as reflective aluminum flakes. An exemplary commercial source of a heat-reflective coating is a ceramic-aluminum barrier coating available from Hy-Tech Thermal Solutions, LLC or equivalents thereof.

Intermediate outer surface 36 of metal foil 32 and an inner surface 14 of shell 24 is an annular space or gap 42. Based on the external dimensions of metal foil wrapped pipe 20 (and heating elements 28), and the internal dimensions of shell 24, the dimensions of annular space 42 will vary. As is depicted in FIG. 1, annular space 42 may not comprise symmetrical dimensions. In one embodiment of the present invention, annular space 42 provides a minimum of 0.75 inches between outer surface 36 of metal foil 32 and inner surface 14 of shell 24.

Exterior to shell 24 is provided insulating material 12. A single insulating material or a combination of different insulating materials may be utilized. In one embodiment of the present invention, insulating material 12 comprises an aerogel. In an exemplary embodiment, insulating material 12 comprises a silica aerogel. In one aspect, the aerogel has an emissivity of k=0.15 at 300 degrees Fahrenheit. An exemplary source of such an aerogel material is a silica aerogel available from Aspen Aerogels, Inc. and marketed as Pyrogel® or equivalents thereof. Other non-metallic aerogels may be utilized. Conventional insulation as is generally known in the art may be used in lieu of an aerogel.

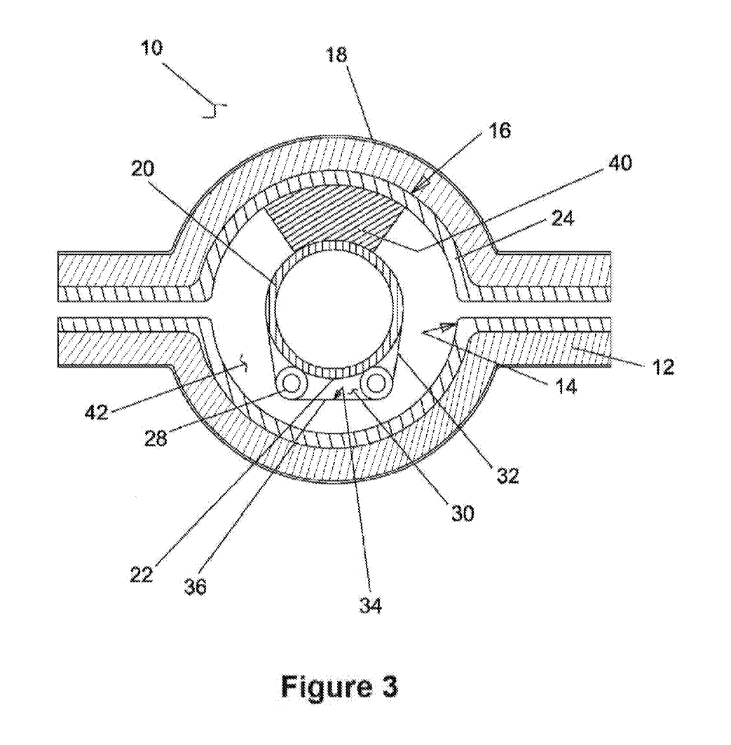

Shell 24 may any comprise any thickness suitable to provide desired support and/or insulating properties. Shell 24 may comprise a single, substantially tubular structure, or shell 24 may comprise a plurality of sub-structures, as depicted in FIG. 3, that form shell 24 when combined. In one embodiment of the present invention, shell 24 comprises one or more fittings (not shown) adapted to facilitate connection of the pipe insulation system to a support structures (not shown) and/or connection of measurement devices and sensors (not shown) to the pipe insulation system.

Insulating material 12 may be provided as a single layer of material or as a plurality of layers. If multiple layers are utilized, the layers may comprise the same or different insulating materials 12. A layer of insulating material 12 may be affixed to an exterior surface 16 of shell 24. Such affixing may comprise the use of glue or other adhesive. Optional additional layers of insulating material 12 may be affixed to an outer surface of a previously provided insulating material 12 layer. The total thickness of all insulating material 12 may be of any thickness suitable to provide desired insulating properties. In one embodiment of the present invention, insulating material 12 comprises an aerogel having a thickness of about 10 millimeters.

In one embodiment of the present invention, a protective coating (not shown) is applied to an exterior surface 18 of the outermost layer of insulating material 12. In another embodiment of the present invention, a second shell (not shown) may be provided circumferentially to exterior surface 18, either in conjunction with use of a protective coating or in lieu thereof.

As would be understood by one skilled in the art, the heat retention and/or insulating characteristics of the present invention may be optimized based on adjustment of any or all of the above listed parameters.

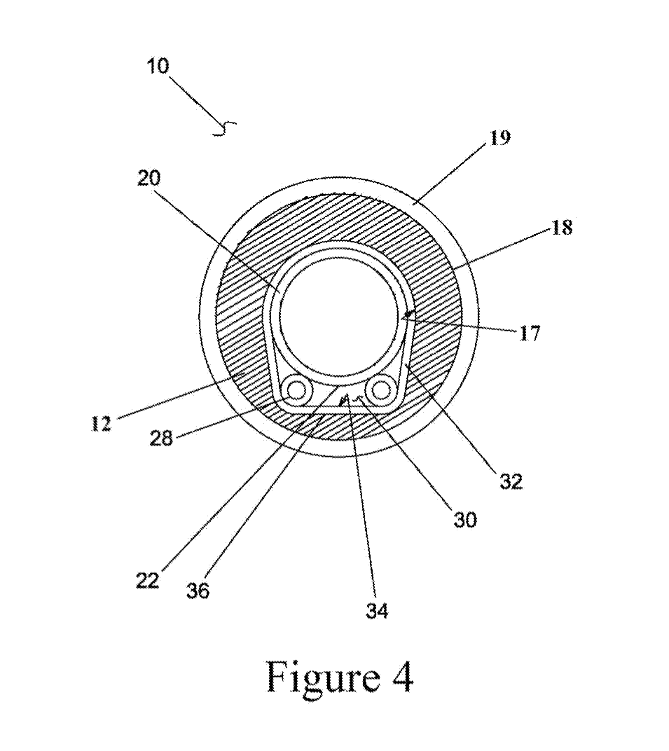

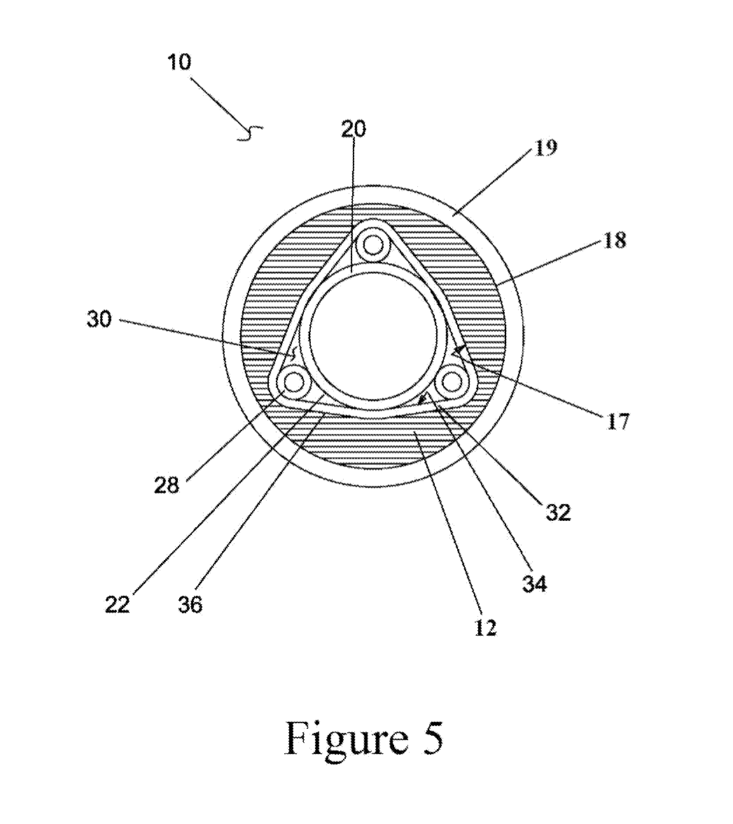

In an alternative embodiment of the present invention, as depicted in FIGS. 4 and 5, a metal foil 32 is wrapped around pipe 20 and heating elements 28, if pipe 20 is so equipped, as described above. An insulating material is provided substantially circumferentially to foil wrapped pipe 20. In the embodiment depicted in FIGS. 4 and 5, the insulating material comprises insulating material 12 described above. In one embodiment, the insulating material may be disposed at least partially in contact with the outer surface 36 of metal foil 32. In one embodiment, the insulating material may be at least partially spaced from the outer surface 36 of metal foil 32, by one or more spacers (not shown) or any suitable means of providing such spacing. The insulating material may be applied as a single layer or as a plurality layers. A single insulating material or a combination of different insulating materials may be utilized. If multiple layers are utilized, the layers may comprise the same or different insulating materials. In one embodiment, each of one or more layers of insulating material has a thickness of about 5 millimeters. In one embodiment, a total thickness of insulating material of between about 10 millimeters and about 20 millimeters is employed. In one embodiment, an adhesive is used to adhere an interior surface 17 of the insulating material to the outer surface 36 of metal foil 32. In one embodiment, the adhesive used is SuperTak™ High Performance Aerosol Adhesive, available from Bostik, Inc.

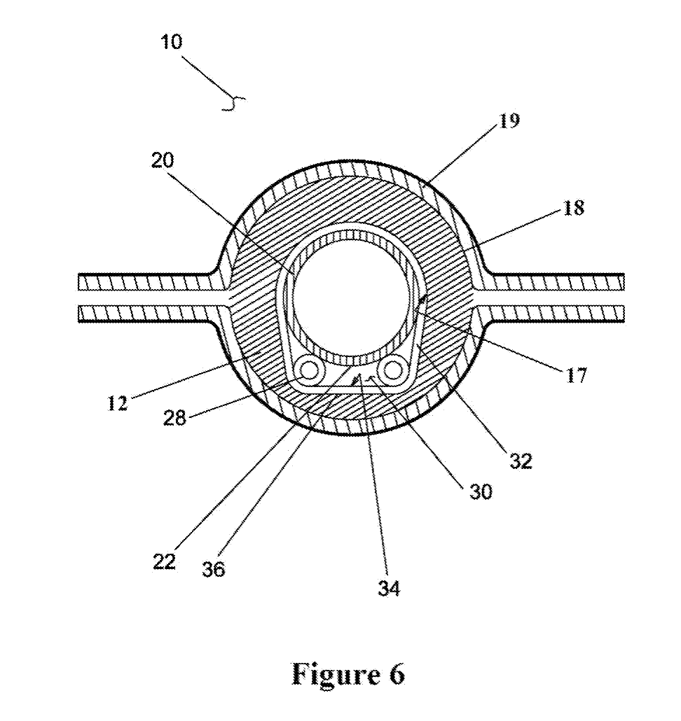

In one embodiment, disposed substantially directly circumferentially to the exterior surface 18 of the insulating material is a protective shell 19. Protective shell 19 may comprise any material suitable for use in a particular industrial application, as would be understood by one skilled in the art, such as but not limited to, a metal or metal alloy, which may comprise aluminum or stainless steel. In one embodiment, protective shell 19 comprises a thickness of about 16 gauge (about 1.51 millimeters for stainless steel), although any suitable thickness may be employed. Protective shell 19 may comprise a single substantially annular component, or may comprise a plurality of components that when cooperatively arranged provide a protective shell. In one embodiment, depicted in FIG. 6, protective shell 19 comprises two substantially semi-circular components. In various embodiments, such as an embodiment depicted in FIG. 6, two or more protective shell 19 components are cooperatively joined using screws and/or clamps (not shown), although any suitable means of component attachment may be employed. In one embodiment, a protective coating (not shown) may be applied to the exterior surface 18 of the insulating material in lieu of or in addition to protective shell 19.

### Experimental Results

The following results were obtained utilizing an embodiment of the invention substantially as depicted in FIG. 1. With room temperature (solid) sulfur in a 4 inch (NPS) pipe, a steam generator produced a flow of 60# steam through two tracers. Surface thermocouples were mounted on the pipe, the outside of the aluminum foil, and on the outside of the shell (underneath the insulation). The foil was spiral wrapped and had approximately 6 layers. Ten millimeters of insulation was applied to the outside of the shell. The foil temperature rose to 200 degrees Fahrenheit in 5 minutes, and the temperature gain thereafter flattened out, reaching a maximum of 262 degrees Fahrenheit. The pipe temperature rose steadily, climbing to the melting point of sulfur of 248 degrees Fahrenheit in less than 60 minutes. The pipe temperature maxed out at 278 degrees Fahrenheit. Liquid sulfur was exiting a hole at the midpoint of the pipe at 1.5 hours.

### Method

An embodiment of a method of insulating a pipe or vessel structure equipped with one or more external heating elements comprises the following steps:
1. wrapping the structure and the external heating elements, such as heating elements 28, with a metal foil, such as metal foil 32, comprising a heat-reflective surface, such as heat-reflective surface 34, wherein the wrapping provides the heat-reflective surface facing the pipe or vessel and the external heating elements;
2. providing one or more spacers, such as spacers 40, exterior to the metal foil;
3. providing circumferentially to the metal foil wrapped structure a shell, such as shell 24, comprising a heat-reflective inner surface, such as heat-reflective inner surface 14, whereby the one or more spacers maintain separation of the shell from the metal foil wrapped structure;
4. providing insulating material, such as insulating material 12, exterior to the shell; and
5. (optionally) providing a protective coating on, and/or a second shell circumferential to, the exterior surface of an outermost layer of the insulating material.

Variations or modifications of embodiments of a method of the present invention are contemplated in accordance with the teachings provided herein and the general skill in the art. For example, in other embodiments of a method of the present invention, a structure not equipped with external heating elements may be employed. In other embodiments of a method of the present invention, either or both of a metal foil and a shell may not comprise a heat-reflective surface. In another embodiment of a method of the present invention, spacers may not be provided, and a shell comprising a heat-reflective inner surface provided circumferentially to the metal foil wrapped structure may be maintained in separation from the metal foil wrapped structure by another means, such as connection of a portion of the shell to pipe components such as flanges, or connection, directly or indirectly, of the shell to an external support structure. In one embodiment, no spatial separation may be maintained between the shell and the metal foil wrapped structure.

An embodiment of an alternative method of insulating a pipe or vessel structure equipped with one or more external heating elements comprises the following steps:
1. wrapping the structure and the external heating elements, such as heating elements 28, with a metal foil, such as metal foil 32, comprising a heat-reflective surface, such as heat-reflective inner surface 34, wherein the wrapping provides the heat-reflective surface facing the pipe or vessel and the external heating elements;
2. providing circumferentially to the metal foil wrapped structure an insulating material, such as insulating material 12, at least partially in contact with the outer surface of the metal foil; and
3. (optionally) providing a protective coating on, and/or a protective shell, such as protective shell 19, circumferential to, the exterior surface of an outermost layer of the insulating material.

Variations or modifications of embodiments of an alternative method of the present invention are contemplated in accordance with the teachings provided herein and the general skill in the art. For example, in other embodiments of an alternative method of the present invention, a structure not equipped with external heating elements may be employed. In other embodiments of an alternative method of the present invention, a metal foil may not comprise a heat-reflective surface.

While the present invention has been disclosed and discussed in connection with the foregoing embodiments, it will be understood that the invention is not limited to the embodiments disclosed, but is capable of numerous rearrangements, modifications, and substitutions of parts and elements without departing from the spirit and scope of the invention. The extent and scope of the invention is set forth in the appended claims and is intended to extend to equivalents thereof.

I claim:

1. A system for insulating a pipe or process vessel structure comprising:
metal foil;
a shell; and
insulating material; wherein:
said structure is configured to maintain or provide in a molten state a material subject to solidification at ambient temperatures;
said metal foil is wrapped circumferentially around said structure and is disposed intermediate said structure and said shell;
said shell is disposed substantially circumferentially to said structure; and
said insulating material is disposed proximate and external to an outer surface of said shell.

2. The system of claim 1, wherein said shell is spaced from an outer surface of said metal foil.

3. The system of claim 2, wherein one or more heating elements are disposed intermediate said structure and said metal foil.

4. The system of claim 2, comprising one or more spacers disposed intermediate said metal foil and said shell and adapted to maintain spatial distance there between.

5. The system of claim 2, wherein said metal foil comprises a heat-reflective surface facing said structure.

6. The system of claim 2, wherein said shell comprises an inner heat-reflective surface facing said metal foil wrapping.

7. The system of claim 2, wherein said shell comprises a plurality of components cooperative arranged.

8. The system of claim 2, wherein said material subject to solidification at ambient temperatures comprises sulfur.

9. A method for insulating a pipe or process vessel structure comprising:
wrapping said structure with metal foil;
providing circumferentially to said structure a shell; and
providing insulating material exterior to said shell; wherein:
said structure is configured to maintain or provide in a molten state a material subject to solidification at ambient temperatures; and
said metal foil is disposed intermediate said structure and said shell.

10. The method of claim 9, wherein one or more heating elements are disposed proximate said structure, and wrapping said structure with said metal foil comprises wrapping said one or more heating elements with said metal foil.

11. The method of claim 9, comprising providing one or more spacers intermediate said metal foil and said shell, said spacers adapted to maintain spatial distance there between.

12. The method of claim 9, wherein said metal foil comprises a heat-reflective surface facing said structure.

13. The method of claim 9, wherein said shell comprises an inner heat-reflective surface facing said metal foil wrapping.

14. The method of claim 9, wherein said material subject to solidification at ambient temperatures comprises sulfur.

15. A system for insulating a pipe or process vessel structure comprising:
metal foil; and
insulating material; wherein:
said structure is configured to maintain or provide in a molten state a material subject to solidification at ambient temperatures;
said metal foil is wrapped circumferentially around said structure and is disposed intermediate said structure and said insulating material; and
said insulating material is disposed substantially circumferentially to an outer surface of said metal foil.

16. The system of claim 15, comprising at least one component selected from the group consisting of:
a shell disposed substantially circumferentially to an outer surface of said insulating material; and
a coating applied to an outer surface of said insulating material.

17. The system of claim 16, wherein one or more heating elements are disposed intermediate said structure and said metal foil.

18. The system of claim 16, wherein said metal foil comprises a heat-reflective surface facing said structure.

19. The system of claim 16, wherein said shell comprises a plurality of components cooperative arranged.

20. The system of claim 16, wherein said insulating material comprises a plurality of layers.

21. The system of claim 16, wherein a least a part of an inner surface of said insulating material is disposed in contact with said outer surface of said metal foil.

22. The system of claim 16, wherein said material subject to solidification at ambient temperatures comprises sulfur.

23. A method for insulating a pipe or process vessel structure comprising:
wrapping said structure with metal foil;
providing insulating material exterior to an outer surface of said metal foil; wherein:
said structure is configured to maintain or provide in a molten state a material subject to solidification at ambient temperatures; and
said metal foil is disposed intermediate said structure and said insulating material.

24. The method of claim 23, comprising at least one step selected from the group consisting of:
providing substantially circumferentially to an outer surface of said insulating material a shell; and
applying a coating to an outer surface of said insulating material.

25. The method of claim 24, wherein one or more heating elements are disposed proximate said structure, and wrapping said structure with said metal foil comprises wrapping said one or more heating elements with said metal foil.

26. The method of claim 24, wherein said metal foil comprises a heat-reflective surface facing said structure.

27. The method of claim 24, wherein said shell comprises a plurality of components cooperative arranged.

28. The method of claim 24, wherein said material subject to solidification at ambient temperatures comprises sulfur.

29. The method of claim 24, wherein said insulating material comprises a plurality of layers.
